(19) United States
(12) Patent Application Publication
(10) Pub. No.: US 2010/0297973 A1
(43) Pub. Date: Nov. 25, 2010

(54) ORTHOGONALITY COMPENSATING DEVICE, RADIO RECEIVING DEVICE, ORTHOGONALITY COMPENSATING METHOD, AND NON-TRANSITORY COMPUTER READABLE MEDIUM

(75) Inventors: Yuji Yamamoto, Kanagawa (JP); Ryouichi Yokoyama, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/766,572

(22) Filed: Apr. 23, 2010

(30) Foreign Application Priority Data
May 19, 2009 (JP) 2009-120746

(51) Int. Cl. H04B 1/10

(52) U.S. Cl. 455/285

(57) ABSTRACT

Provided is an orthogonality compensating device that compensates for orthogonality between a real signal and an imaginary signal of complex digital intermediate frequency signals, the orthogonality compensating device including: a first processing unit that outputs a first signal obtained by calculating one of the real signal and the imaginary signal by using a first coefficient and a second coefficient; and a coefficient specifying unit that specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.

This application is based upon and claims the benefit of priority from Japanese patent application No. 2009-120746, filed on May 19, 2009, the disclosure of which is incorporated herein in its entirety by reference.

### BACKGROUND

1. Field of the Invention

The present invention relates to a radio receiving device having a function of frequency conversion such as superheterodyne, and particularly to a radio receiving device having a function to eliminate an image frequency signal that has a complex conjugate relationship with a radio received signal.

2. Description of Related Art

Heretofore, techniques to eliminate an image frequency signal have been proposed. For example, Japanese Patent No. 3902498 discloses a radio signal receiving device having a function of orthogonal frequency conversion. FIG. 8 shows a configuration of a radio signal receiving device disclosed in Japanese Patent No. 3902498. An orthogonal detector 2 converts received radio signals including a desired frequency signal received by an antenna device 1 into complex intermediate frequency signals by frequency-converting the received signals using a signal cos and a signal−sin, which are output from a local-generated signal generator 21, by mixers 22 and 23, respectively. The complex intermediate frequency signals are quantized by each of analog-digital converters (ADCs) 3a and 3b, and orthogonality and amplitude characteristics of the signals are compensated for by a characteristic compensator 4, and the compensated signals are inputted to a complex mixer 5. The complex mixer 5 completely cancels the image frequency signal, which has a complex conjugate relationship with the desired frequency signal, from the signals whose orthogonality and amplitude characteristics are compensated for in principle to generate only the desired frequency signal. Only the desired frequency signal is sent to a wave detector 6 and is subjected to detection processing Then, the desired frequency signal is transferred to a latter processing phase to provide users with services.

For the sake of easy explanation, modulating information is omitted, and only a signal carrier is taken into consideration. It is assumed that a desired frequency signal is represented by cos (x+fif), an image frequency signal which has a complex conjugate relationship with the desired frequency signal is represented by cos (x-fif), and a signal output from the local-generated signal generator 21 is represented by cos (x) or −sin (x). Symbols x and fif represent values that satisfy 0≦x<360°, 0≦fif<360°, 0≦x+fif<360°, and 0≦x−fif<360°.

In the case of receiving the desired frequency signal, an output signal (signal F22) from the mixer 22 is expressed as follows.

$$\begin{matrix}F 22 = cos ( x + fif ) * cos ( x ) \\ = 0.5 * cos ( fif )\end{matrix}$$

An output signal (signal F23) from the mixer 23 is expressed as follows.

$$\begin{matrix}F 23 = cos ( x + fif ) * \{ - sin ( x ) \} \\ = 0.5 * sin ( fif )\end{matrix}$$

A high frequency component occurring in the mixers 22 and 23 is eliminated by a filtering processing (not shown), so that the complex intermediate frequency signals are composed of only low frequency signals. Detailed description is omitted here.

In the complex mixer 5, the signals F22 and F23 are converted using the signal cos (fif) or the signal −sin (fif) and are obtained as follows.

$$\begin{matrix}F 22 * cos ( fif ) - F 23 * \{ - sin ( fif ) \} = 0.5 * cos ( fif ) cos ( fif ) + \\ 0.5 * sin ( fif ) sin ( fif ) \\ = 0.25 * cos ( 2 * fif ) + \\ 0.25 * cos ( 0 ) - \\ 0.25 * cos ( 2 * fif ) + \\ 0.25 * cos ( 0 ) \\ = 0.5 * cos ( 0 )\end{matrix} \qquad ( 1 )$$

Further,

$$F 23 * cos ( fif ) + F 22 * \{ - sin ( fif ) \} = 0.5 * sin ( fif ) cos ( fif ) - 0.5 * cos ( fif ) sin ( fif ) = 0.25 * sin ( 2 * fif ) + 0.25 * sin ( 0 ) - 0.25 * sin ( 2 * fif ) + 0.25 * sin ( 0 ) = 0.5 * sin ( 0 ) \qquad ( 2 )$$

In the case of receiving the image frequency signal, the output signal from the mixer 22 is expressed as follows.

$$\begin{matrix}F 22 = cos ( x - fif ) * cos ( x ) \\ = 0.5 * cos ( fif )\end{matrix}$$

The output signal from the mixer 23 is expressed as follows.

$$\begin{matrix}F 23 = cos ( x - fif ) * \{ - sin ( x ) \} \\ = - 0.5 * sin ( fif )\end{matrix}$$

As noted in the description of the reception of the desired frequency signal, a high frequency component occurring in the mixers 22 and 23 is eliminated by a filtering processing (not shown), so that the complex intermediate frequency signals are composed of only low frequency signals.

In the complex mixer 5, the signals F22 and F23 are converted using the signal cos (fif) and the signal−sin (fif) and are obtained as follows.

$$F 22 * cos ( fif ) - F 23 * \{ - sin ( fif ) \} = 0.5 * cos ( fif ) cos ( fif ) - 0.5 * sin ( fif ) sin ( fif ) = 0.25 * cos ( 2 * fif ) + 0.25 * cos ( 0 ) + 0.25 * cos ( 2 * fif ) - 0.25 * cos ( 0 ) = 0.5 * cos ( 2 * fif ) \qquad ( 3 )$$

Further,

$$F 23 * cos ( fif ) + F 22 * \{ - sin ( fif ) \} = - 0.5 * sin ( fif ) cos ( fif ) - 0.5 * cos ( fif ) sin ( fif ) = - 0.25 * sin ( 2 * fif ) - 0.25 * sin ( 0 ) - 0.25 * sin ( 2 * fif ) + 0.25 * sin ( 0 ) = - 0.5 * sin ( 2 * fif ) \qquad ( 4 )$$

That is, the expressions (1) and (2) show that the desired frequency signal is converted into a zero IF signal by the complex mixer 5, and the expressions (3) and (4) show that the image frequency signal is subjected to complex transformation in a high frequency range. Consequently, it can be explained that the complex mixer 5 divides the desired frequency signal and the image frequency signal, and a low-pass filter removes a high frequency component, thereby completely canceling the image frequency signal from the desired frequency signal.

The radio signal receiving device as described above is able to downsize high frequency components, such as an analog filter for removing an image frequency signal, or an antenna tuner. This contributes to a reduction in cost, and thus the radio signal receiving device is applied to a wide range of fields such as a television tuner, a satellite broadcasting receiver, a communication instrument, or the like.

As noted above, an image frequency signal can be completely canceled in theory. However, practically, there are variations in circuit characteristics and property fluctuation depending on temperature change. Therefore, it is effective to compensate for the characteristics by a specific adaptive signal processing in the characteristic compensator 4. Japanese Patent No. 3439036 discloses an example of the characteristic compensator 4 disclosed in Japanese Patent No. 3902498. Japanese Patent No. 3439036 discloses a specific example of an orthogonality and amplitude error compensating circuit to perform the adaptive signal processing. FIG. 9 shows a configuration of an amplitude error compensating circuit disclosed in Japanese Patent No. 3439036. An embodiment of Japanese Patent No. 3439036 specifies that coefficients h1, h2, and h3 of FIG. 9 are processed by the adaptive signal processing. This makes it possible to compensate for the characteristics with high accuracy.

The orthogonality and amplitude error compensating circuit disclosed in Japanese Patent No. 3439036 uses CMA (Constant Modules Algorithm) as an evaluation function for performing the adaptive signal processing. Coefficient update expressions used in Japanese Patent No. 3439036 are as follows.

h_{1,k}=h_{1,k-1}+μ(Y.Q)*(S.Q)e

h_{2,k}=h_{2,k-1}+μ(Y.I)*(S.Q)e

h_{3,k}=h_{3,k-1}+μ(Y.I)*(S.I) e (5)

where σ denotes an amplitude value of a desired signal, and e=σ²−(Y.I²+Y.Q²)

Further, k is an integer greater than zero (k>0) and indicates an elapsed time.

Processing of the expressions Y.I=h3*S.I and Y.Q=h1*S.Q+h2*S.I is preformed using the coefficients h1, h2, and h3, which are adaptively updated by the expression (5), to thereby obtain a real number axis signal (Y.I) and an imaginary number axis signal (Y.Q) whose orthogonality and amplitude error are compensated for.

The updating expression of the coefficient h_{2,k} as shown in the expression (5) is used to compensate for orthogornality between Y.I and Y.Q. When the orthogonality is maintained, the value “e” is zero. That is, the coefficient h2 is held at a value obtained when the orthogonality is maintained.

The adaptability of the device disclosed in Japanese Patent No. 3902498 using the technique of Japanese Patent No. 3439036 described above is significantly reduced depending on a difference in signal level between the desired frequency signal and the image frequency signal, quality characteristics of the input signal, or the like. In order to prevent this shortage, the level of the image frequency signal is detected, the adaptive signal processing is performed when the level of the image frequency signal is equal to or greater than a threshold, and the adaptive signal processing is suspended when the level of the image frequency signal is less than the threshold. Therefore, until detection of a condition where the image frequency signal is relatively stable, users cannot receive satisfactory service, because users have to receive the desired frequency signal which is interfered by an image disturbing signal.

The coefficients are converged by adaptive signal processing using the expression (5) while the image frequency signal is stable. Due to the adaptive signal processing, the coefficients maintain the orthogonality with respect to the image frequency signal, but the coefficients do not maintain the orthogonality with respect to the desired frequency signal. This makes a difference to the detection performance of a detection output from the wave detector 6.

Further, in the technique disclosed in Japanese Patent No. 3902498, when the adaptive signal processing is performed in a condition where the desired frequency signal and the image frequency signal coexist, there are variation factors such as a variation factor due to reverse directions of adaptive control, and a variation factor due to a forward direction of adaptive control. In the case of the variation factor due to the reverse directions of adaptive control, the orthogonality is not compensated. In the technique disclosed in Japanese Patent No. 3902498, the adaptive signal processing is performed exclusively when the image frequency signal is relatively stable, thereby preventing this problem.

In general, the orthogornality is lost due to variations of device circuit characteristics and property fluctuation caused by temperature change, such as an orthogonality variation between the signal cos and signal−sin output from the local-generated signal generator 21, or a delay variation in the mixers 22 and 23 as shown in FIG. 8. Though not shown in FIG. 8, in practice, an analog filter needs to be provided between the orthogonal detector 2 and the ADCs 3a and 3b, which causes a group delay variation.

Japanese Patent No. 3439036 discloses that it is effective to perform characteristics compensation by the adaptive signal processing in the characteristic compensator 4 in order to compensate for these variations. Here, the above-mentioned analog filter is a factor that causes the reverse directions of the adaptive control between the desired frequency signal and the image frequency signal. The analog filter has an influence on the group delay variation. This reason will be explained, assuming that a phase error β occurs in the ADC 3b alone.

In the case of receiving the desired frequency signal, when the amplitude of each input to the characteristic compensator 4 is normalized to one, the following expressions are obtained.

S.I=cos(fif)

S.Q=sin(fif+β)

The characteristic compensator 4 adaptively changes the coefficient h2 so as to compensate for the orthogonality.

$$Y . I = cos ( fif ) \\ \begin{matrix}Y . Q = sin ( fif + β ) + h 2 * cos ( fif ) \\ = √ \{ 1 + {( h 2 )}^{2} \} * sin ( fif + β + θ )\end{matrix} \\ where θ = {sin}^{- 1} ( h 2 / √ \{ 1 + {( h 2 )}^{2} \} ) \qquad ( 6 )$$

That is, when the adaptive control is performed to adjust the second coefficient h2 so as to satisfy θ=−β, the expression (6) is transformed as follows.

√{1+(h2)²}*sin(fif)

The amplitude error is controlled by the coefficients h1 and h3. A detailed description thereof is omitted so as not to detract from the present invention.

In the case of receiving the image frequency signal, when the amplitude of each input to the characteristic compensator 4 is normalized to one, the following expressions are obtained.

S.I=cos(fif)

S.Q=−sin(fif+β)

The compensator 4 adaptively changes the second coefficient h2 so as to compensate for the orthogonality.

$$Y . I = cos ( fif ) \\ \begin{matrix}Y . Q = sin ( - fif - β ) + h 2 * cos ( fif ) \\ = √ \{ 1 + {( h 2 )}^{2} \} * sin ( - fif - β + θ )\end{matrix} \\ where θ = {sin}^{- 1} ( h 2 / √ \{ 1 + {( h 2 )}^{2} \} ) \qquad ( 7 )$$

That is, when the adaptive control is performed to adjust the second coefficient h2 so as to satisfy θ=0, the expression (7) is transformed as follows.

−√{+(h2)²}*sin (fif)”

The amplitude error is controlled by the coefficients h1 and h3. A detailed description thereof is omitted so as not to detract from the present invention.

As described above, in each case of receiving the desired frequency signal and the image frequency signal, when the phase error β occurs, the directions of the adaptive control are reverse to each other. For this reason, it is necessary that the image frequency signal and the desired frequency signal exist separately in order to control orthogonality compensation.

For example, it is assumed that γ denotes a phase correction amount calculated using a coefficient shown in the expression (5) which is corrected using the image frequency signal. When the desired frequency signal is received in this condition, a phase difference of −2γ occurs in the desired frequency signal. Thus the orthogonality with respect to the desired frequency signal is not compensated.

Factors that cause the directions of adaptive control for the desired frequency signal and image frequency signal to coincide with each other include an orthogonality variation between the signal con and signal−sin output from the local-generated signal generator 21 shown in FIG. 8. This is explained below.

It is assumed that the phase error a occurs in the signal−sin alone. In the case of receiving the desired frequency signal, an output form the mixer 22 is expressed as follows.

$$\begin{matrix}F 22 = cos ( x + fif ) * cos ( x ) \\ = 0.5 * cos ( fif )\end{matrix}$$

An output from the mixer 23 is expressed as follows.

$$\begin{matrix}F 23 = cos ( x + fif ) * \{ - sin ( x + α ) \} \\ = 0.5 * sin ( fif - α )\end{matrix}$$

When the amplitude of each input to the characteristic compensator 4 is normalized to one, the following expressions are obtained.

S.I=cos(fif)

S.Q=sin(fif—α)

The characteristic compensator 4 adaptively changes the second coefficient h2 so as to compensate for the orthogonality.

$$Y . I = cos ( fif ) \\ \begin{matrix}Y . Q = sin ( fif - α ) + h 2 * cos ( fif ) \\ = √ \{ 1 + {( h 2 )}^{2} \} * sin ( fif - α + θ )\end{matrix} \\ where θ = {sin}^{- 1} ( h 2 / √ \{ 1 + {( h 2 )}^{2} \} ) \qquad ( 8 )$$

That is, when the adaptive control is performed to adjust the second coefficient h2 so as to satisfy θ=α, the expression (8) is transformed as follows.

√{1+(h2)²}*sin(fif)

The amplitude error is controlled by the coefficients h1 and h3. A detailed description thereof is omitted so as not to detract from the present invention.

In the case of receiving the image frequency signal, an output from the mixer 22 is expressed as follows.

$$\begin{matrix}F 22 = cos ( x - fif ) * cos ( x ) \\ = 0.5 * cos ( fif )\end{matrix}$$

An output from the mixer 23 is expressed as follows.

$$\begin{matrix}F 23 = cos ( x - fif ) * \{ - sin ( x + α ) \} \\ = 0.5 * sin ( - fif - α )\end{matrix}$$

When the amplitude of each input to the characteristic compensator 4 is normalized to one, the following expressions are obtained.

S.I=cos(fif)

S.Q=sin(−fif −α)

The characteristic compensator 4 adaptively changes the second coefficient h2 so as to compensate for the orthogonality.

$$Y . I = cos ( fif ) \\ \begin{matrix}Y . Q = sin ( - fif - α ) + h 2 * cos ( fif ) \\ = √ \{ 1 + {( h 2 )}^{2} \} * sin ( - fif - α + θ )\end{matrix} \\ where θ = {sin}^{- 1} ( h 2 / √ \{ 1 + {( h 2 )}^{2} \} ) \qquad ( 9 )$$

That is, when the adaptive control is performed to adjust the second coefficient h2 so as to satisfy θ=α, the expression (9) is transformed as follows.

√{1+(h2)²}*sin(fif)

The amplitude error is controlled by the coefficients h1 and h3. A detailed description thereof is omitted so as not to detract from the present invention.

As described above, in each case of receiving the desired frequency signal and the image frequency signal, when the phase error a occurs, the directions of the adaptive control coincide with each other.

In general, the signal cos and the signal−sin occur in the device. Even though an absolute delay occurs, variations due to relative factors can be suppressed. However, the analog filter is a discrete component, and therefore has a large relative variation. That is, the phase error β is more liable to occur than the phase error α.

If the factors for the phase error β are large, the ability of adaptive control deteriorates when the image frequency signal and the desired frequency signal coexist. Therefore, the related art proposes that, upon detection of the level of the image frequency signal, the adaptive control is performed when the image frequency is equal to or greater than a given threshold, and the adaptive control is suspended when the image frequency signal is smaller than the threshold, thereby avoiding deterioration in the ability of adaptive control. As a result, until detection of a condition where the image frequency signal is relatively stable, users have to receive the desired frequency signal interfered by the image frequency signal, and cannot receive satisfactory service, as described above.

Further, the coefficients represented by the expression (5), which are converged by the adaptive signal processing while the image frequency signal is stable, maintain the orthogonality with respect to the image frequency signal, but the coefficients do not maintain the orthogonality with respect to the desired frequency signal. In addition, there is a problem that this makes a difference to detection performance of a detection output from the wave detector 6.

### SUMMARY

The present inventors have found a problem that there is no technique to compensate for the orthogonality even when both of the desired frequency signal and the image frequency signal coexist.

A first exemplary aspect of the present invention is an orthogonality compensating device that compensates for orthogonality between a real signal and an imaginary signal of complex digital intermediate frequency signals, the orthogonality compensating device including: a first processing unit, and a coefficient specifying unit. The first processing unit outputs a first signal obtained by calculating one of the real signal and the imaginary signal by using a first coefficient and a second coefficient. The coefficient specifying unit specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.

Concerning the value of a coefficient (second coefficient h2, for example) to compensate for the orthogonality between the real signal and the imaginary signal, a value obtained based on the desired frequency signal is equal to a value obtained based on the image frequency signal. Then, a coefficient obtained after the orthogonal compensation based on the desired frequency signal is also effective in receiving the image frequency signal. This provides an advantageous effect that an ability to eliminate the image frequency signal is obtained without waiting for an arrival of the image frequency signal.

A second exemplary aspect of the present invention is a radio receiving device including: a frequency converter that obtains complex intermediate frequency signals depending on a frequency of a received signal by using a local signal represented by a complex signal; a quantizer that transforms the complex intermediate frequency signals to complex digital intermediate frequency signals; an orthogonal compensator that compensates for orthogonality between a real signal and an imaginary signal of the complex digital intermediate frequency signals by using the orthogonality compensating device described above; a complex mixer that divides the real signal and the imaginary signal compensated for by the orthogonal compensator into a desired frequency signal and an image frequency signal in accordance with a frequency range, the image frequency signal falling within a range of an image frequency having a complex conjugate relationship with a frequency of the desired frequency signal; and a detector that detects a signal output from the complex mixer.

A third exemplary aspect of the present invention is an orthogonality compensating method that compensates for orthogonality between a real signal and an imaginary signal of complex digital intermediate frequency signals, the orthogonality compensating method including: outputting a first signal obtained by calculating one of the real signal and the imaginary signal by using a first coefficient and a second coefficient; specifying the first coefficient such that the first signal has the same amplitude as the other of the real signal and the imaginary signal, by using the first signal and the other of the real signal and the imaginary signal, and specifying the second coefficient such that the first signal is orthogonal to the other of the real signal and the imaginary signal.

A fourth exemplary aspect of the present invention is a non-transitory computer readable medium that stores a program to compensate for orthogonality between a real signal and an imaginary signal of complex digital intermediate frequency signals, the program causing a computer to execute processing including: a first processing that outputs a first signal obtained by calculating one of the real signal and the imaginary signal by using a first coefficient and a second coefficient; and a coefficient specifying processing that specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.

According to the exemplary aspects of the present invention, it is possible to provide a technique to compensate for the orthogonality even when both the desired frequency signal and the image frequency signal coexist.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an exemplary configuration of a radio receiving device according to a first exemplary embodiment of the present invention;

FIG. 2 is a block diagram showing an exemplary configuration of an orthogonal compensator according to the first exemplary embodiment of the present invention;

FIG. 3 is a block diagram showing another exemplary configuration of an orthogonal compensator according to the first exemplary embodiment of the present invention;

FIG. 4 is a block diagram showing further another exemplary configuration of an orthogonal compensator according to the first exemplary embodiment of the present invention;

FIG. 5 is a block diagram showing further another exemplary configuration of an orthogonal compensator according to the first exemplary embodiment of the present invention;

FIG. 6 is a block diagram showing an exemplary configuration of a radio receiving device according to a second exemplary embodiment of the present invention;

FIG. 7 is a block diagram showing an exemplary configuration of an orthogonal compensator according to the second exemplary embodiment of the present invention;

FIG. 8 is a block diagram showing a configuration of a radio signal receiving device disclosed in Japanese Patent No. 3902498; and

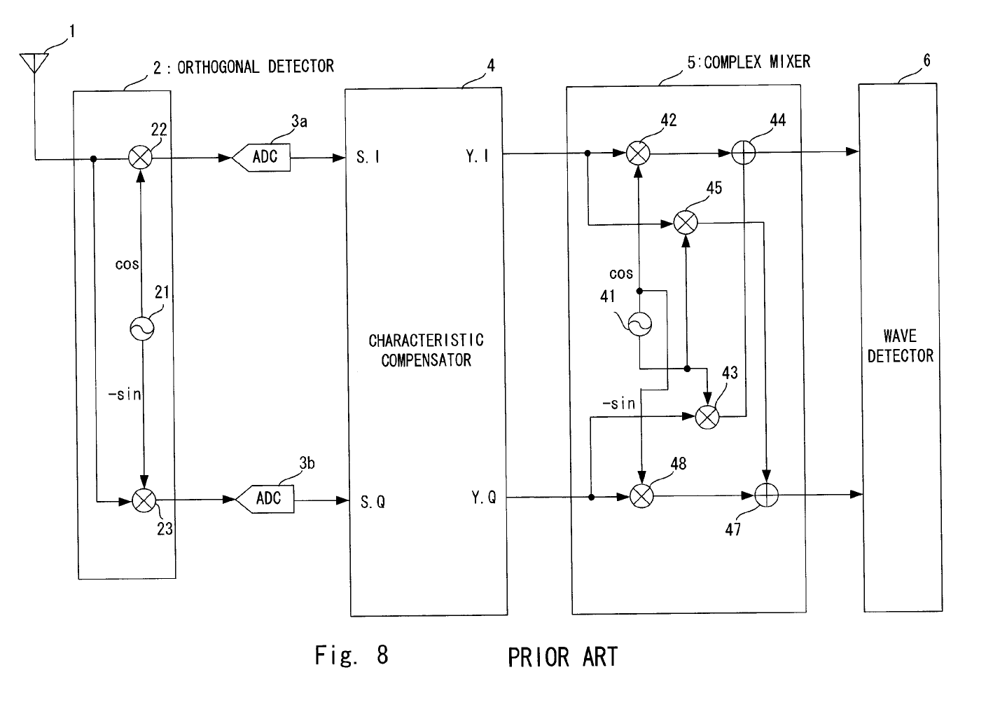

FIG. 9 is a block diagram showing a configuration of an amplitude error compensating circuit disclosed in Japanese Patent No. 3439036.

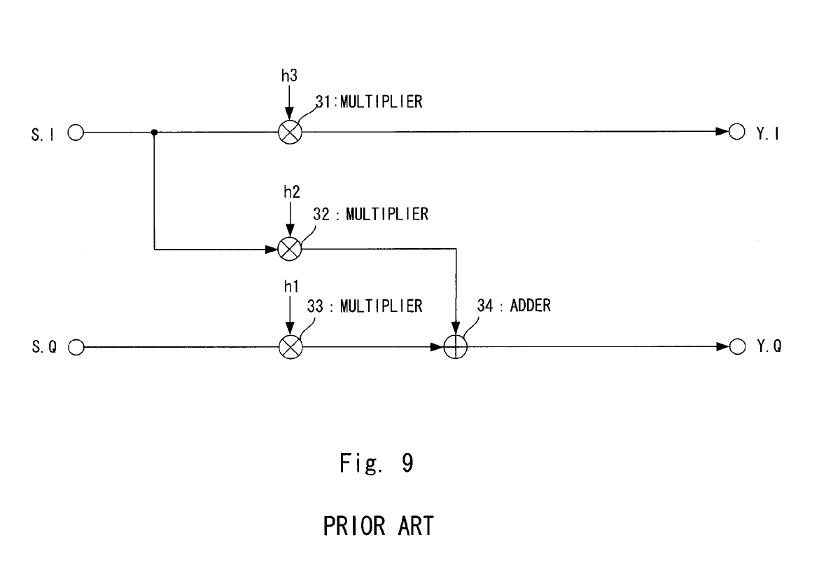

### DETAILED DESCRIPTION OF THE EXEMPLARY EMBODIMENTS

Exemplary embodiments of the present invention will be described hereinafter with reference to the drawings. The following description and the attached drawings are appropriately shortened and simplified to clarify the explanation. In the drawings, the structural elements and equivalents having an identical structure or function are denoted by the identical reference symbols, and the redundant explanation thereof is omitted.

### First Exemplary Embodiment

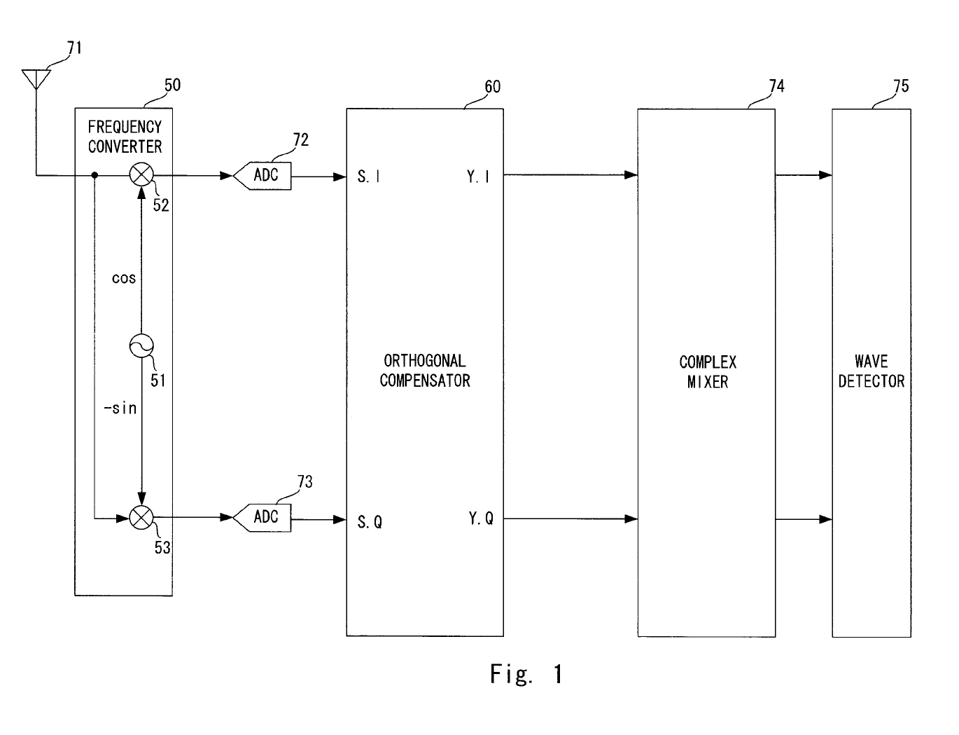

FIG. 1 is a block diagram showing an exemplary configuration of a radio receiving device according to a first exemplary embodiment of the present invention. The radio receiving device includes an antenna 71, a frequency converter 50, quantizers (ADC) 72 and 73, an orthogonal compensator (orthogonality compensating circuit) 60, a complex mixer 74, and a wave detector 75.

The frequency converter 50 obtains complex intermediate frequency signals depending on the frequency of a received signal by using a local signal represented by a complex signal. Specifically, the mixers 22 and 23 perform frequency conversion using a signal cos and a signal −sin which are generated by a local-generated signal generator 51, resulting in conversion into the complex intermediate frequency signals.

The quantizers 72 and 73 quantize the complex intermediate frequency signals to obtain complex digital intermediate frequency signals.

The orthogonal compensator 60 compensates for the orthogonality between a real signal and an imaginary signal in the obtained complex digital intermediate frequency signals.

The complex mixer 74 divides the signal output from the orthogonal compensator 60 into a desired frequency signal and an image frequency signal in accordance with a frequency range.

The wave detector 75 extracts only a frequency band of the desired frequency signal from the signal output from the complex mixer 74 by using a filtering processing, and detects the signal output after the filtering processing.

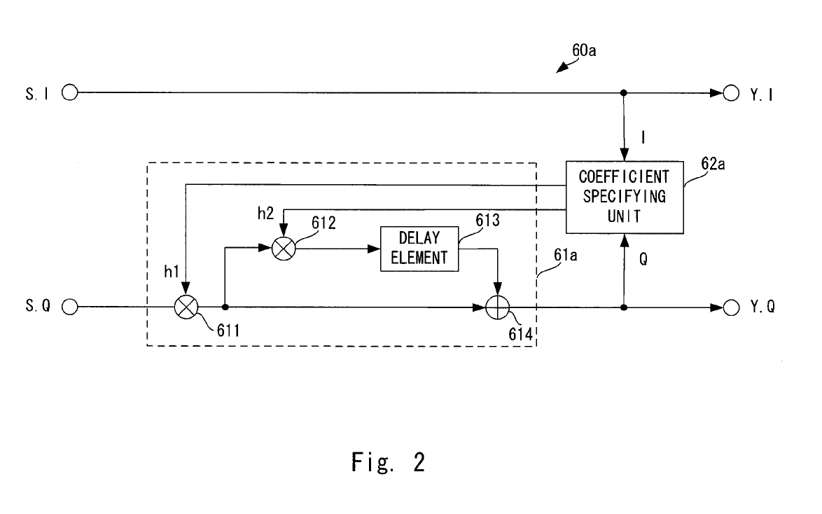

Next, the orthogonal compensator 60 will be explained using a specific configuration example. FIGS. 2 to 5 are block diagrams showing an exemplary configuration of the orthogonal compensator (orthogonality compensating device).

An orthogonal compensator 60a shown in FIG. 2 includes a first processing unit 61a and a coefficient specifying unit 62a.

The first processing unit 61a outputs a first signal (first calculation signal) which is obtained by calculating one of the real signal (signal I) and the imaginary signal (signal Q) by using a first coefficient h1 and a second coefficient h2. Referring to FIG. 2, the first processing unit 61a outputs the first signal which is obtained by calculating the imaginary signal by using the first coefficient h1 and the second coefficient h2.

The coefficient specifying unit 62a specifies the first coefficient h1 such that the first signal has the same amplitude as the other of the real signal and the imaginary signal, and specifies the second coefficient h2 such that the first signal is orthogonal to the other of the real signal and the imaginary signal, by using the first signal and the other of the real signal and the imaginary signal.

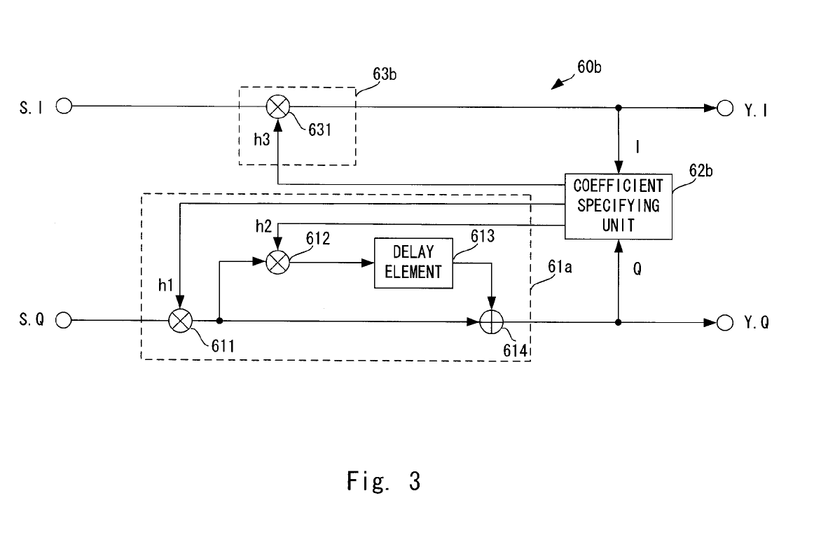

FIG. 2 shows, by way of example, that the first processing unit 61a selects the imaginary signal as the one of the real signal and the imaginary signal and selects the real signal as the other of the real signal and the imaginary signal, and the reverse case may also be applied. That is, the first processing unit 61a may select the real signal as the one of the real signal and the imaginary signal, select the imaginary signal as the other of the real signal and the imaginary signal, and output the first signal obtained by calculating the real signal by using the first coefficient h1 and the second coefficient h2. Further, the coefficient specifying unit 62a may select the imaginary signal as the other of the real signal and the imaginary signal, specify the first coefficient h1 such that the first signal has the same amplitude as the imaginary signal, and specify the second coefficient h2 such that the first signal is orthogonal to the imaginary signal, by using the first signal and the imaginary signal. The following description will be given using an example where the imaginary signal is selected as the one of the real signal and the imaginary signal and the real signal is selected as the other of the real signal and the imaginary signal. The relationship between the one signal and the other signal in FIGS. 3 to 5 is similar to that in FIG. 2.

FIG. 2 shows, by way of example, that the first processing unit 61a is implemented using multipliers 611 and 612, a delay element 613, and an adder 614.

The multiplier 611 multiplies the imaginary signal by the first coefficient h1. The multiplier 612 multiplies the imaginary signal by the second coefficient h2. The delay element 613 delays a signal output from the multiplier 612. A delay amount of the delay element 613 is specified by one skilled in the art as a matter of design variation. The adder 614 adds a signal output from the multiplier 611 and a signal output from the delay element 613.

An orthogonal compensator 60b shown in FIG. 3 includes the first processing unit 61a, a coefficient specifying unit 62b, and a second processing unit 63b.

The first processing unit 61a is the same as that shown in FIG. 2.

The second processing unit 63b outputs a second signal (second calculation signal) obtained by calculating the other of the real signal and the imaginary signal and a third coefficient h3. Referring to FIG. 3, the second processing unit 63b outputs the second signal which is obtained by multiplying the real signal by the third coefficient h3.

The coefficient specifying unit 62b specifies the first coefficient h1 and the third coefficient h3 such that the first signal has the same amplitude as the second signal, and specifies the second coefficient h2 such that the first signal is orthogonal to the second signal.

FIG. 3 shows, by way of example, that the second processing unit 63b is implemented using a multiplier 631. The multiplier 631 multiplies the real signal by the third coefficient h3.

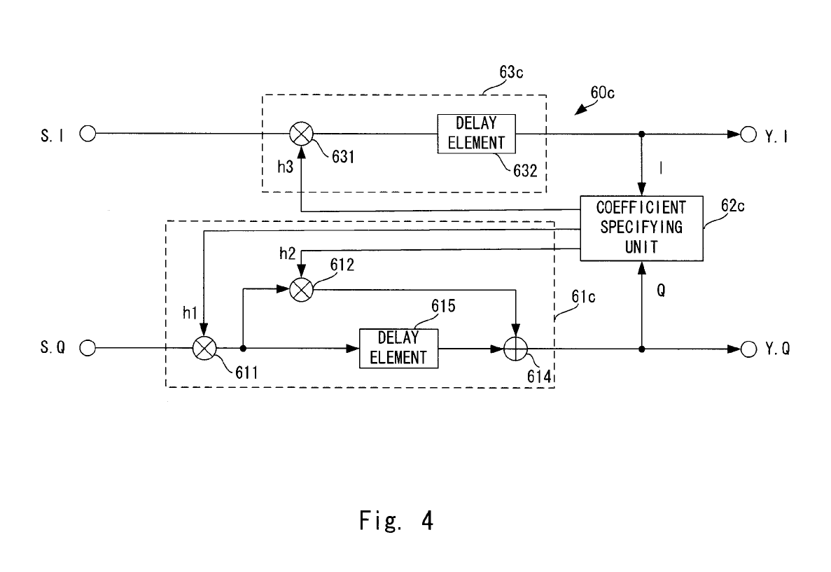

An orthogonal compensator 60c shown in FIG. 4 includes a first processing unit 61c, a coefficient specifying unit 62c, and a second processing unit 63c.

The first processing unit 61c has the same function as that shown in FIG. 2, but has a different configuration. In particular, the first processing unit 61c delays a signal obtained by multiplying the imaginary signal (one of the real signal and the imaginary signal) by the first coefficient h1, and generates the first signal by adding the delayed signal and a signal obtained by multiplying the imaginary signal by the second coefficient h2.

The second processing unit 63c generates the second signal by delaying a signal obtained by multiplying the real signal (the other of the real signal and the imaginary signal) by the third coefficient h3.

The coefficient specifying unit 62c specifies the first coefficient h1 and the third coefficient h3 such that the first signal has the same amplitude as the second signal. The coefficient specifying unit 62c also specifies the second coefficient h2 such that the first signal is orthogonal to the second signal.

FIG. 4 shows, by way of example, that the first processing unit 61c is implemented using the multipliers 611 and 612, the adder 614, and a delay element 615. The multipliers 611 and 612 and the adder 614 are the same as those shown in FIG. 2. The delay element 615 delays the signal output from the multiplier 611.

The second processing unit 63c is implemented using the multiplier 631 and a delay element 632. The multiplier 631 multiplies the real signal by the third coefficient h3. The delay element 632 delays the signal output from the multiplier 631.

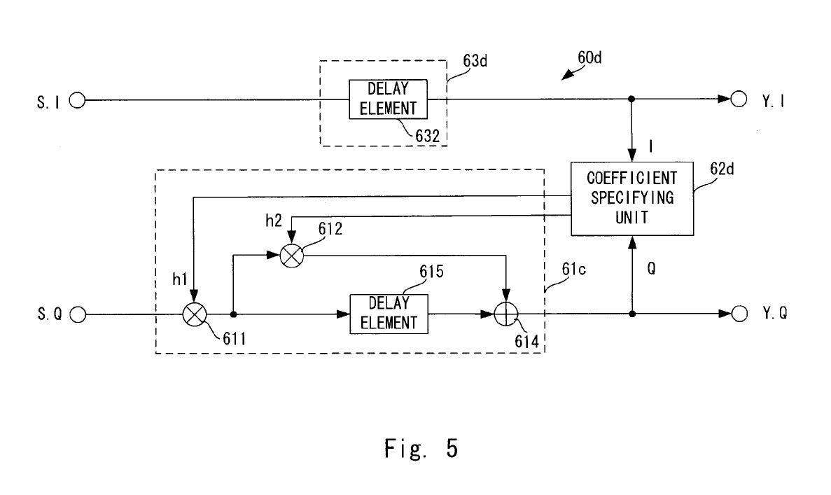

An orthogonal compensator 60d shown in FIG. 5 includes the first processing unit 61c, a coefficient specifying unit 62d, and a second processing unit 63d.

The first processing unit 61c is the same as that shown in FIG. 3.

The second processing unit 63d generates the second signal by delaying the real signal (the other of the real signal and the imaginary signal).

The coefficient specifying unit 62d specifies the first coefficient h1 such that the first signal has the same amplitude as the second signal. The coefficient specifying unit 62d also specifies the second coefficient h2 such that the first signal is orthogonal to the second signal.

FIG. 5 shows, by way of example, that the second processing unit 63d is implemented using the delay element 632. The delay element 632 delays the real signal.

Next, description is given of a specific operation of the orthogonal compensator 60 according to this exemplary embodiment when a phase error occurs in two digital analog convertors. It is assumed that a phase error 13 occurs in the quantizer 73.

In the case of receiving the desired frequency signal, the signals are represented by an expression (10), as with the expression (6) described in the description of related art section.

$$Y . I = cos ( fif ) \\ \begin{matrix}Y . Q = sin ( fif + β ) + h 2 * cos ( fif ) \\ = √ \{ 1 + {( h 2 )}^{2} \} * sin ( fif + β + θ )\end{matrix} \\ where θ = {sin}^{- 1} ( h 2 / √ \{ 1 + {( h 2 )}^{2} \} ) \qquad ( 10 )$$

That is, when the adaptive control is performed to adjust the second coefficient h2 so as to satisfy θ=−β, the expression (10) is transformed as follows.

√{1+(h2)²}*sin(fif)

On the other hand, in the case of receiving the image frequency signal, it is apparent that the expression (7) described in the description of related art section is transformed as follows.

$$Y . I = cos ( fif ) \\ \begin{matrix}Y . Q = - sin ( fif + β ) - h 2 * cos ( fif ) \\ = - √ \{ 1 + {( h 2 )}^{2} \} * sin ( fif + β + θ )\end{matrix} \\ where θ = {sin}^{- 1} ( h 2 / √ \{ 1 + {( h 2 )}^{2} \} ) \qquad ( 11 )$$

That is, when the adaptive control is performed to adjust the second coefficient h2 so as to satisfy θ=−β, the expression (11) is transformed as follows.

√{1+(h2)²}*sin(fif)

As described above, in each case of receiving the desired frequency signal and the image frequency signal, when the phase error β occurs, the directions of the adaptive control are oriented in the same direction. That is, even if the adaptive control processing and calculation of the second coefficient h2 are performed when the desired frequency signal and the image frequency signal coexist, the control directions are oriented in the same direction and the signals are held stable. Therefore, there is no need for the embodiment disclosed in Japanese Patent No. 3902498.

The coefficient update expression used in the coefficient specifying units 62a-62d are expressed as follows.

$${h}_{1 , k} = {h}_{1 , k - 1} + μ ( Y . Q ) * ( S . Q ) e \\ {h}_{2 , k} = \{ \begin{matrix}{h}_{2 , k - 1} - & μ ( Y . I ) * ( S . Q ) e \\ & when Y . I shifts from Y . Q by 0 < x < π / 2 \\ {h}_{2 , k - 1} + & μ ( Y . I ) * ( S . Q ) e \\ & when Y . I shifts from Y . Q by - π / 2 < x < 0\end{matrix} \\ {h}_{3 , k} = {h}_{3 , k - 1} + μ ( Y . I ) * ( S . Q ) e \\ where μ is a parameter to specify a convergence capacity , σ denotes an amplitude value of a desired frequency signal , and e = {σ}^{2} - ( Y . {I}^{2} + Y . {Q}^{2} ) \qquad ( 12 )$$

It is possible to compensate for the phase error occurring in the quantizers 72 and 73, and to cause the directions of the adaptive control coincide with each other by updating the coefficients by the use of the expression (12). These are made possible by adjustment of the second coefficient h2 depending on the magnitude of the difference between the first signal and the second signal, in particular between Y.I and Y.Q. as shown by the expression (12).

Further, it is possible to compensate for the orthogonality by adjustment of the first coefficient h1 and the third coefficient h3 (only in the case of using the third coefficient) such that the first signal is orthogonal to the second signal.

According to this exemplary embodiment, it is possible to provide a technique to control directions of phase correction control to be oriented in the same direction with respect to the desired frequency signal and the image frequency signal, and to compensate for the orthogonality even when both the desired frequency signal and the image frequency signal coexist.

### Second Exemplary Embodiment

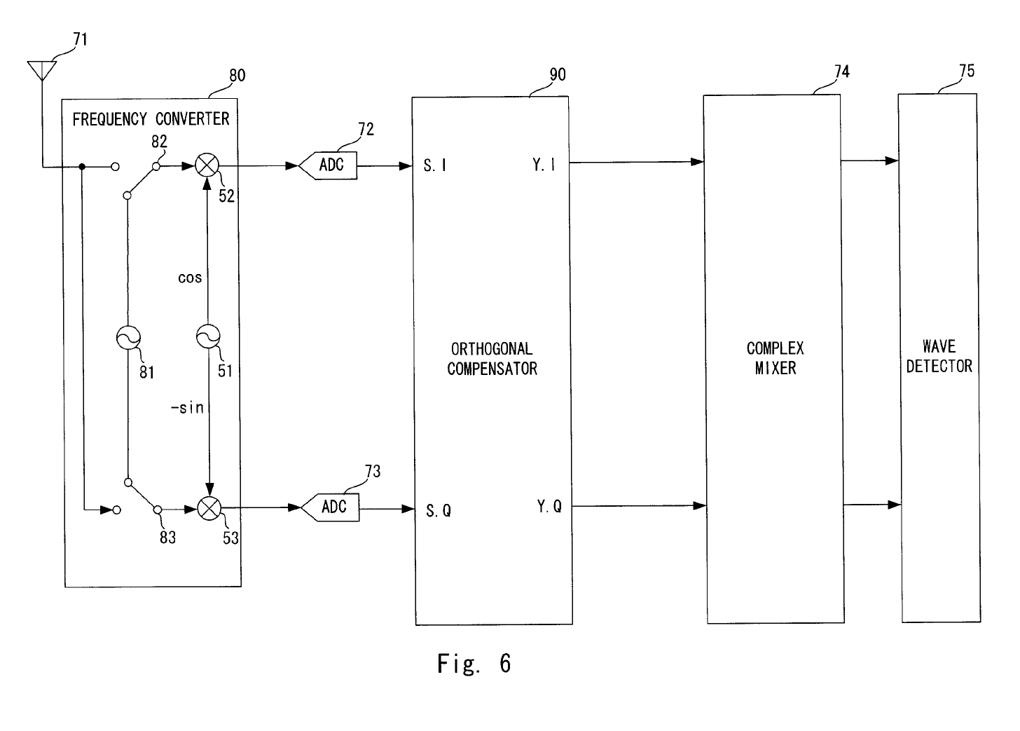

FIG. 6 is a block diagram showing an exemplary configuration of a radio receiving device according to a second exemplary embodiment of the present invention. In the radio receiving device of this exemplary embodiment, a frequency converter 80 further includes a function that generates a revision signal to be output to the quantizers 72 and 73. Specifically, in addition to the function to obtain the complex intermediate frequency signals depending on the frequency of the received signal using the local signal represented by a complex signal, the converter 80 includes a revision signal generator 81 and switches 82 and 83.

The revision signal generator 81 generates a revision signal.

The switches 82 and 83 select a signal to be output to the quantizers 72 and 73. In particular, the switches 82 and 83 select one of the received signal (the desired frequency signal or the image frequency signal) received by the antenna 71 and the revision signal generated by the revision signal generator 81.

The revision signal is a known signal which is used to calculate a coefficient in a state unaffected by a radio wave environment.

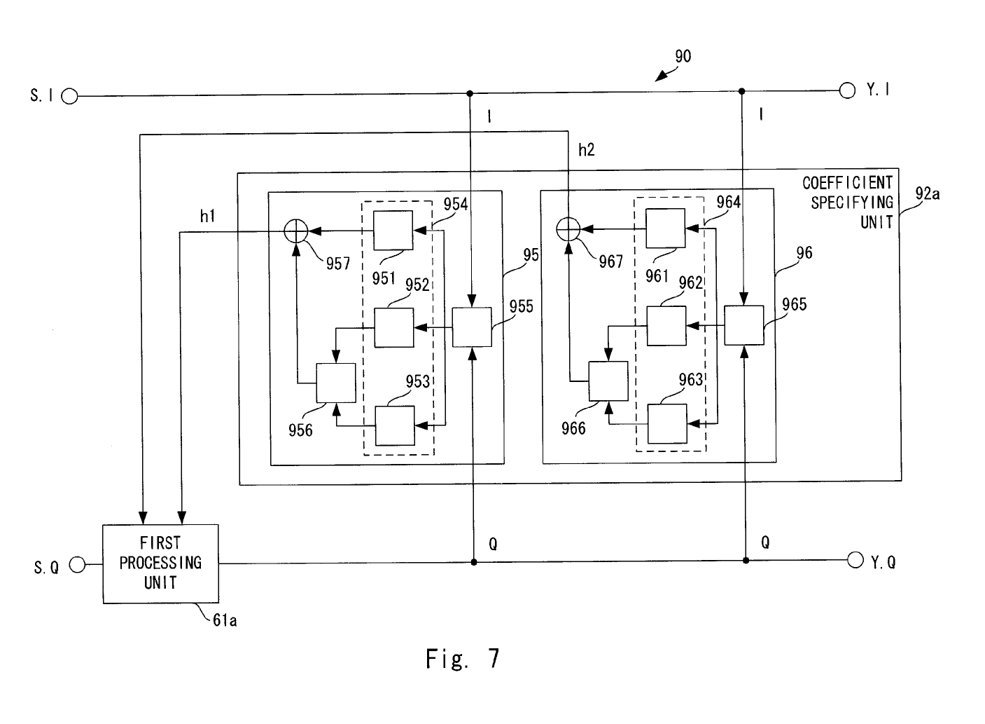

The orthogonal compensator 90 as shown in FIG. 6 has the same configuration as one of FIGS. 2-5. The orthogonal compensator 90 has a function of specifying a coefficient using the revision signal, in addition to the functions of the coefficient specifying units 62a to 62d. FIG. 7 shows an exemplary configuration of the orthogonal compensator of this exemplary embodiment.

FIG. 7 shows an exemplary configuration of a coefficient specifying unit 92a having the function of the orthogonal compensator 62a as shown in FIG. 2 as well as the function of this exemplary embodiment. The coefficient specifying unit 92a includes a first coefficient specifying unit (first coefficient corrector) 95 and a second coefficient specifying unit (second coefficient corrector) 96. The first coefficient specifying unit 95 includes a register unit 954, a coefficient calculator 955, a correction amount calculator 956, and an adder 957. The second coefficient specifying unit 96 includes a register unit 964, a coefficient calculator 965, a correction amount calculator 966, and an adder (operation unit) 967.

The register unit 954 is a storage area (memory) to hold a number of coefficient values for the first coefficient h1. The register unit 964 is a storage area (memory) to hold a number of coefficient values for the second coefficient h2. The register unit 954 includes a first register 951, a second register 952, and a third register 953. Similarly, the register unit 964 includes a first register 961, a second register 962, and a third register 963. The register unit 954 holds three kinds of information for the first coefficient h1 in each register. The register unit 964 holds three kinds of information for the second coefficient h2 in each register.

The coefficient calculator 955 calculates the first coefficient h1. The coefficient calculator 965 calculates the second coefficient h2.

The correction amount calculators 956 and 966 calculate a correction amount to adjust a coefficient value with time. For example, the correction amount calculators 956 and 966 calculate a correction amount (an amount of temperature drift) that changes with temperature change.

The adder 957 adds the coefficient value held in the first register 951 and the correction amount calculated by the correction amount calculator 956. The adder 967 adds the coefficient value held in the first register 961 and the correction amount calculated by the correction amount calculator 966.

The coefficient specifying unit 92a updates values of the first coefficient h1 and the second coefficient h2, referring to a number of coefficient values held in the register units 954 and 964.

The following description will be given assuming that the first coefficient h1 stored in the first register 951 is a value “h1-1”, the first coefficient h1 stored in the second register 952 is a value “h1-2”, and the first coefficient h1 stored in the third register 953 is a value “h1-3”. The following description will be given using the first coefficient h1, because the coefficient specifying unit 92a performs similar operations for both the first coefficient h1 and the second coefficient h2.

Exemplary operations will be explained with reference to FIG. 7. When the power of the radio receiving device is turned on, the revision signal generator 81 generates the revision signal. The switches 82 and 83 are switched so as to output the revision signal.

When the power is turned on, the coefficient specifying unit 92a receives a real signal or an imaginary signal, which is replaced with the received signal received through the antenna 71, depending on the revision signal. First, the coefficient calculator 955 calculates the first coefficient h1 (revision value of coefficient) using the revision signal and stores the calculated first coefficient h1 as the value h1-1 in the first register 951.

Next, after a lapse of a given time since the power of the radio receiving device is turned on, the coefficient calculator 955 calculates the first coefficient h1 (initial value of the second coefficient) using the received signal (desired frequency signal) received by the antenna 71. The given time is a period where each function is started up upon power-on, and the radio receiving device starts to receive the signal received through the antenna 71, for example. In this case, the coefficient calculator 955 may first use the received signal received through the antenna 71. The coefficient calculator 955 calculates the first coefficient h1 using the received signal and stores the calculated first coefficient h1 as the value h1-2 in the second register 952.

After a lapse of an arbitrary time, the coefficient calculator 955 calculates the first coefficient h1 (elapsed value of the first coefficient) using a newly received signal, and stores the first coefficient h1 newly calculated as the value h1-3 in the third register 953. Further, after a lapse of an arbitrary time, the coefficient calculator 955 calculates the first coefficient h1 using a newly received signal and replaces the value h1-3 held in the third register 953 with the first coefficient h1 newly calculated. As a result, the value h1-3 held in the third register 953 is updated after a lapse of an arbitrary time.

The coefficient corrector 92a generates the first coefficient h1 using information of the first coefficient h1 held in the register unit 954. In particular, the correction amount calculator 956 calculates a difference between the value h1-2 held in the second register 952 and the value h1-3 held in the third register 953 as the correction amount. Then, in the coefficient corrector 92a, the adder 957 adds the correction amount calculated and the value h1-1 held in the first register 951 when the sign is plus, or subtracts the correction amount calculated from the value h1-1 when the sign is minus to calculate the first coefficient h1.

While FIG. 7 shows an exemplary configuration which includes the register units 954 and 964 for each of the first coefficient h1 and the second coefficient h2,respecrively, an exemplary configuration may include a single register unit which holds values for one of the first coefficient h1 and the second coefficient h2. When the register unit holds values for one of the first coefficient h1 and the second coefficient h2, the coefficient specifying unit calculates the one of the first coefficient h1 and the second coefficient h2 by using the values held by the register unit, and calculates the other of the first coefficient h1 and the second coefficient h2 in the same manner as the first exemplary embodiment. Further, each of the orthogonal compensators 60b-60d shown in FIGS. 3-5 also includes a register unit which stores a coefficient calculated by using the revision signal, or the like in the same manner as in FIG. 7.

Since the orthogonal compensator according to this exemplary embodiment has the configuration as shown in FIGS. 6 and 7, the register unit can hold three kinds of values (values of the first coefficient, the second coefficient, or third coefficient). In particular, the first register holds the first value calculated by the initial orthogonality compensation using the revision signal. The second register holds the second value calculated by the orthogonality compensation using the revision signal. The third register holds the third value calculated by othtogonality compensation using the desired frequency signal after a lapse of a given time. The amount of temperature drift in the desired frequency signal is calculated using the second value and the third value. Then, the coefficient can be calculated by subtracting the amount of temperature drift in the desired frequency signal from the value corrected initially by the revision signal (for example, h1-1) or by adding the amount of temperature drift in the desired frequency signal to the value corrected initially by the revision signal.

In the case of calculating the coefficient depending on the revision signal, the coefficient specifying unit 92a can correct a phase error a that depends on a delay caused by characteristics variations of a device circuit and the like included in the radio receiving device, and property fluctuation due to temperature change, because the revision signal is a known signal. Further, in the case of calculating the coefficient based on the received signal, the coefficient specifying unit 92a can detect the correction amount of the phase error β occurring due to the influence of communication environments such as a radio wave state in which the received signal is transferred. Accordingly, the coefficient specifying unit 92a can calculate the coefficient to correct the phase error a and the phase error β using the coefficient calculated depending on the revision signal and the coefficient calculated depending on the received signal. This makes it possible to compensate for the initial phase variations more accurately than the first exemplary embodiment.

In general, a compensation depending on temperature change is necessary after start-up of the radio receiving device. The compensation depending on temperature change can be carried out by obtaining a difference (amount of temperature drift) between the coefficient calculated based on the received signal initially and the coefficient calculated based on the received signal after a lapse of a given time.

Further, according to the configuration as described above, the correction of the amount of temperature drift with respect to the image frequency signal is complete. That is, it is possible to calculate a coefficient capable of eliminating the image frequency signal before an arrival of the image frequency signal. Accordingly, the ability of eliminating of the image frequency signal is maintained before the arrival of the image frequency signal. This is because the orthogonal compensator according to this exemplary embodiment has a configuration in which the directions of control for correcting the amount of temperature drift due to the analog filter coincide with each other between the desired frequency signal and the image frequency signal, unlike the configuration of the related art.

### Third Exemplary Embodiment

A third exemplary embodiment will be described in which the value of the coefficient (here, the second coefficient) is limited. Because the error amount which is the phase error a or the phase error β as described above is mainly caused by characteristics variations or variations due to environmental changes, the error amount is generally negligible if the correction can be carried out several times. Therefore, an exemplary configuration is employed to limit a permissible range of the coefficient, and to control a limiter to prevent any difficulty in adjustment of the coefficient due to a rapid change of an input signal electric field. Specifically, a coefficient specifying unit calculates the second coefficient h2 so as to be set within a given range. The coefficient specifying unit specifies a maximum value when the value calculated is larger than the given range, and specifies a minimum value when the value is smaller than the given range.

Even when adaptive convergence is difficult due to a rapid change of an input signal electric field or depending on the quality of the received signal, a steady condition of the adaptive signal processing can be recovered without spread of the adaptive signal processing, by limiting the permissible range of the coefficient.

### Fourth Exemplary Embodiment

The above exemplary embodiments provide the same effects when the phase correcting control is provided to one or both of the signal paths. It is preferable that the phase correcting control is provided to the both of the paths for the real signal and the imaginary signal so that the correction control amounts are set in reverse directions for the paths, if the size of hardware permits.

In that case, when an amplitude change occurs depending on the phase control, the change is made by the same amplitude amount for both passes, which eliminates the need for the first coefficient h1 and the third coefficient h3, as long as a circuit is employed in which the characteristics variations of the circuit and the characteristics variations due to temperature change do not vary in the amplitude direction.

Further, the orthogonal compensator of this exemplary embodiment includes the coefficient specifying unit to update the coefficients in such a way that the output signal (first signal) from the first processing unit and the output signal (second signal) from the second processing unit have an orthogonal relationship and the same amplitude. Though the first and second exemplary embodiments show an example for applying the CMA, the control may also be carried out such that the output signal from the first processing unit and the output signal from the second processing unit have the same amplitude.

That is, a calculation may be made using the following expression (13).

$${h}_{1 , k} = {h}_{1 , k - 1} - μ * {e}_{1} \\ {h}_{2 , k} = \{ \begin{matrix}{h}_{2 , k} = {h}_{2 , k - 1} - μ * {e}_{2} \\ when Y . I shifts from Y . Q by 0 < x < π / 2 \\ {h}_{2 , k} = {h}_{2 , k - 1} + μ * {e}_{2} \\ when Y . I shifts from Y . Q by - π / 2 < x < 0\end{matrix} \\ {h}_{3 , k} = {h}_{3 , k - 1} - μ * {e}_{1} \\ where μ is a parameter to specify a convergence capacity , \\ {e}_{1} = Y . {I}^{2} - Y . {Q}^{2} , \\ {e}_{2} = Y . I * Y . Q . \qquad ( 13 )$$

In this case, a control is performed such that the output signal from the first processing unit and the output signal from second processing unit have relatively the same amplitude. This makes it possible to extract a signal intensity from the signal obtained after orthogonality compensation, which is advantageous for configuring a receiver.

### Other Exemplary Embodiments

The functions of the orthogonal compensator (orthogonality compensating device) and the orthogonality compensating method described in the above exemplary embodiments may be implemented by hardware, firmware, software, or a combination thereof, for example. In the case of using software, the functions may be implemented to cause a computer to execute instructions included in a program. The program is loaded to a computer memory to execute the instructions under control of a central processing unit (CPU). The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

In the radio receiving device shown in FIG. 1, the program may be executed using a CPU and a memory in the orthogonal compensator, or using a CPU to control the complex mixer 74 or the wave detector 75 and a memory to be usable by the CPU.

The program causes the computer to execute at least the following processing: (1) a first processing that outputs a first signal obtained by calculating one of the real signal and the imaginary signal by using a first coefficient and a second coefficient; and (2) a coefficient specifying processing that specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.

As described above, the orthogonal compensator (orthogonality compensating device) according to any one of the exemplary embodiments provides the following advantageous effect. That is, regarding the values of the coefficient (second coefficient h2) for use in compensating for the orthogonality between the real signal and the imaginary signal, the coefficient value obtained based on the image frequency signal is equal to the coefficient value obtained based on the desired frequency signal. For this reason, the coefficient value obtained after orthogonality compensation based on the desired frequency signal is also effective in receiving the image frequency signal. Consequently, the ability of eliminating the image frequency signal is obtained before arrival of the image frequency signal.

The provision of means to generate the revision signal in the radio receiving device and means to hold a plurality of coefficients (for example, a memory or a register) makes it possible to update the coefficients by referring to values of the plurality of coefficients. The use of the revision signal makes it possible to compensate for variations in initial phase of the local signals cos and −sin represented by complex signals of the frequency converter. Therefore, there is an advantageous effect that the orthogonality compensation can be performed with higher accuracy.

Further, applying the amplitude limitation to the coefficients h1, h2, and h3 makes it possible to recover a steady condition without spread of the adaptive signal processing, even when the adaptive convergence is difficult due to a rapid change of an input signal electric field and depending on the quality of the received signal.

For example, according to any one of the above exemplary embodiments, it is possible to provide the radio receiving device including an orthogonal compensator which is preferable for an in-vehicle tuner and suppresses the deterioration in the ability to eliminate the image frequency signal due to a deterioration in characteristics or incompleteness of a circuit or a device.

The first to fourth exemplary embodiments and other exemplary embodiments described above can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. An orthogonality compensating device that compensates for orthogonality between a real signal and an imaginary signal of complex digital intermediate frequency signals, the orthogonality compensating device comprising:
a first processing unit that outputs a first signal obtained by calculating one of the real signal and the imaginary signal by using a first coefficient and a second coefficient; and
a coefficient specifying unit that specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.

2. The orthogonality compensating device according to claim 1, wherein the first processing unit generates the first signal by using a signal obtained by multiplying the one of the real signal and the imaginary signal by the first coefficient and a signal obtained by multiplying the one of the real signal and the imaginary signal by the second coefficient.

3. The orthogonality compensating device according to claim 1, further comprising:
a second processing unit that outputs a second signal obtained by processing the other of the real signal and the imaginary signal.

4. The orthogonality compensating device according to claim 2, further comprising:
a second processing unit that outputs a second signal obtained by processing the other of the real signal and the imaginary signal.

5. The orthogonality compensating device according to claim 3, wherein
the second processing unit generates the second signal by multiplying the other of the real signal and the imaginary signal by a third coefficient, and
the coefficient specifying unit specifies the third coefficient such that the first signal has the same amplitude as the second signal.

6. The orthogonality compensating device according to claim 4, wherein
the second processing unit generates the second signal by multiplying the other of the real signal and the imaginary signal by a third coefficient, and
the coefficient specifying unit specifies the third coefficient such that the first signal has the same amplitude as the second signal.

7. The orthogonality compensating device according to claim 3, wherein
the first processing unit generates a delayed signal by delaying the signal obtained by multiplying the one of the real signal and the imaginary signal by the first coefficient, and adds the delayed signal and the signal obtained by multiplying the one of the real signal and the imaginary signal by the second coefficient, to thereby generate the first signal,
the second processing unit generates the second signal by delaying the signal obtained by multiplying the other of the real signal and the imaginary signal by the third coefficient,
the coefficient specifying unit specifies the third coefficient such that the first signal has the same amplitude as the second signal.

8. The orthogonality compensating device according to claim 3, wherein
the first processing unit generates a delayed signal by delaying the signal obtained by multiplying the one of the real signal and the imaginary signal by the first coefficient, and adds the delayed signal and the signal obtained by multiplying the one of the real signal and the imaginary signal by the second coefficient, to thereby generate the first signal, and
the second processing unit generates the second signal by delaying the other of the real signal and the imaginary.

9. The orthogonality compensating device according to claim 1, further comprising a revision signal generator that generates a revision signal,
wherein the coefficient specifying unit includes a coefficient corrector that holds a revision value of at least one of the first coefficient, the second coefficient, and the third coefficient, the revision value being calculated based on the revision signal, an initial value of the at least one coefficient, the initial value being calculated based on a received signal, and an elapsed value of the at least one coefficient, the elapsed value being calculated based on a received signal that is received after a lapse of a given time since the calculation of the initial value, calculates a correction amount with the lapse of time by using the initial value and the elapsed value, and updates a value obtained by adding the revision value and the correction value as the at least one coefficient.

10. The orthogonality compensating device according to claim 9, wherein the coefficient corrector includes:
a register unit that holds the revision value, the initial value, and the elapsed value; and
a calculator that calculates an amount of temperature drift with the elapsed time as the correction amount by using the initial value and the elapsed value, and adds the amount of temperature drift to the revision value.

11. The orthogonality compensating device according to claim 1, wherein the coefficient specifying unit specifies a permissible range of the second coefficient, and specifies the value of the second coefficient in the specified range.

12. The orthogonality compensating device according to claim 11, wherein the coefficient specifying unit specifies a permissible range of at least one of the first coefficient and the third coefficient, and specifies the value of at least one of the first coefficient and the third coefficient in the specified range.

13. A radio receiving device comprising:
a frequency converter that obtains complex intermediate frequency signals depending on a frequency of a received signal by using a local signal represented by a complex signal;
a quantizer that transforms the complex intermediate frequency signals to complex digital intermediate frequency signals;
an orthogonal compensator that compensates for orthogonality between a real signal and an imaginary signal of the complex digital intermediate frequency signals by using the orthogonality compensating device according to claim 1;
a complex mixer that divides the real signal and the imaginary signal compensated for by the orthogonal compensator into a desired frequency signal and an image frequency signal in accordance with a frequency range, the image frequency signal falling within a range of an image frequency having a complex conjugate relationship with a frequency of the desired frequency signal; and
a detector that detects a signal output from the complex mixer.

14. An orthogonality compensating method that compensates for orthogonality between a real signal and an imaginary signal of complex digital intermediate frequency signals, the orthogonality compensating method comprising:
outputting a first signal obtained by calculating one of the real signal and the imaginary signal by using a first coefficient and a second coefficient;
specifying the first coefficient such that the first signal has the same amplitude as the other of the real signal and the imaginary signal, by using the first signal and the other of the real signal and the imaginary signal, and
specifying the second coefficient such that the first signal is orthogonal to the other of the real signal and the imaginary signal.

15. A non-transitory computer readable medium that stores a program to compensate for orthogonality between a real signal and an imaginary signal of complex digital intermediate frequency signals, the program causing a computer to execute processing comprising:
a first processing that outputs a first signal obtained by calculating one of the real signal and the imaginary signal by using a first coefficient and a second coefficient; and
a coefficient specifying processing that specifies the first coefficient such that the first signal has the same amplitude as the other of the real signal and the imaginary signal, and specifies the second coefficient such that the first signal is orthogonal to the other of the real signal and the imaginary signal, by using the first signal and the other of the real signal and the imaginary signal.
